(19) United States
(12) Patent Application Publication
(10) Pub. No.: US 2013/0088651 A1
(43) Pub. Date: Apr. 11, 2013

(54) LIGHTING DEVICE, DISPLAY DEVICE AND TELEVISION DEVICE

(71) Applicant: Yasumori Kuromizu, Osaka-shi (JP)

(72) Inventor: Yasumori Kuromizu, Osaka-shi (JP)

(21) Appl. No.: 13/703,686

(22) PCT Filed: May 24, 2011
(86) PCT No.: PCT/JP2011/061845

§ 371 Date: Dec. 12, 2012

(30) Foreign Application Priority Data
Jun. 25, 2010 (JP) 2010-145133

(51) Int. Cl. F21V 21/14; G09F 13/26

(52) U.S. Cl. CPC F21V 21/14; G09F 13/26
USPC 348/739; 362/418; 362/97.1

(57) ABSTRACT

Provided is a lighting device configured to prevent or suppress breaking of a discharge tube when a discharge tube gripping member is elastically deformed. A backlight unit according to the present invention includes: a discharge tube 28 including a U-shaped curved portion and electrodes at both ends thereof; a backlight chassis housing the discharge tube 28 on an upper side of a bottom surface thereof; a lamp clip 30 including a main body 30a attached to the bottom surface of the backlight chassis and a lamp rubber 30b disposed on the main body 30a and elastically gripping the curved portion of the discharge tube 28; and a first holder 20 covering the curved portion. The first holder 20 includes a rib 20a protruding in the first holder 20. The rib 20a is in contact with the main body 30a of the lamp clip 30 and spaced apart from the lamp rubber 30b with the curved portion covered by the first holder 20.

### DESCRIPTION

1. Technical Field

The present invention relates to a lighting device, a display device, and a television device.

2. Background Art

As a conventional example of a backlight unit used in a display device, a backlight unit including a discharge tube (such as a U-shaped tube) as a light source is known. The discharge tube includes a tube portion, electrodes disposed at the end portions of the tube portion, and a curved portion formed by bending the tube portion such that the electrodes are oriented in the same direction. In such a backlight unit, the discharge tube may be attached to a backlight chassis by elastically holding the curved portion of the discharge tube with a lamp clip and the like attached to the backlight chassis. In this case, because the discharge tube is elastically held, a structure for preventing loosening due to vibration of the discharge tube is required.

Patent Document 1 discloses a backlight unit including a U-shaped tube with electrodes at the end portions thereof; a backlight chassis housing the U-shaped tube; a lamp clip attached to the backlight chassis and holding the curved portion of the U-shaped tube; and a holder covering the curved portion of the U-shaped tube. In this backlight unit, the holder includes a rib protruding inside thereof. When the curved portion of the U-shaped tube is held by the lamp clip and covered by the holder, the rib of the holder is abutted on a part of the U-shaped tube around the curved portion of the U-shaped tube. Thus, the movement of the U-shaped tube is regulated by the rib of the holder such that the loosening of the lamp clip due to vibration of the U-shaped tube can be prevented.

### RELATED ART DOCUMENT

### Patent Document

Patent Document 1: Japanese Unexamined Patent Publication No. 2009-48873

### Problem to be Solved by the Invention

However, in the backlight unit according to Patent Document 1, a lamp rubber may be elastically deformed by heat generated as the discharge tube emits light, for example. In this case, the lamp rubber may lose freedom such that the stress due to elastic deformation of the lamp rubber may be concentrated at the curved portion of the discharge tube held by the lamp rubber, possibly resulting in the breaking of the discharge tube. Further, even if a configuration is adopted such that the loosening due to the vibration of the discharge tube is prevented by having the rib of the holder abutted on the lamp rubber, the lamp rubber may lose freedom when the lamp rubber is elastically deformed because the lamp rubber is regulated by the rib, possibly resulting in the breaking of the discharge tube.

### DISCLOSURE OF THE PRESENT INVENTION

The present invention was made in view of the foregoing circumstances. An object of the present invention is to provide a lighting device such that the breaking of a discharge tube can be prevented or suppressed when a discharge tube gripping member is elastically deformed.

### Means for Solving the Problem

The technology disclosed in the present description relates to a lighting device including a discharge tube including a tube having a curved portion, a chassis including a bottom surface and housing the discharge tube on one side of the bottom surface, a discharge tube attaching member including a main body and an elastic gripping member, and a holder covering the curved portion of the tube of the discharge tube. The curved portion is formed by bending a part of the tube. The main body is attached to the bottom surface of the chassis and the elastic gripping member is provided on the main body and elastically grips the curved portion of the tube of the discharge tube. The holder includes a rib protruding in the holder. The rib is in contact with the main body of the discharge tube attaching member and spaced apart from the elastic gripping member of the discharge tube attaching member, with the curved portion of the discharge tube covered by the holder.

According to the above lighting device, when the curved portion of the tube of the discharge tube is covered by the holder, the discharge tube attaching member is held by the rib of the holder via the main body, while the elastic gripping member of the discharge tube attaching member is not regulated. Thus, with the curved portion of the discharge tube covered by the holder, the stress generated in the elastic gripping member of the discharge tube attaching member upon elastic deformation of the elastic gripping member can be released while the discharge tube attaching member is held. Accordingly, transmission of the stress generated in the elastic gripping member to the discharge tube can be prevented or suppressed, and thereby the breaking of the discharge tube can be prevented or suppressed.

The rib included in the holder may include a plurality of ribs, and the ribs may be in contact with the main body of the discharge tube attaching member, with the curved portion of the discharge tube covered by the holder.

In this configuration, because the plurality of ribs are in contact with the main body of the discharge tube attaching member, the discharge tube attaching member can be effectively held.

The ribs included in the holder may be each arranged on each side of the elastic gripping member of the discharge tube attaching member, with the curved portion of the discharge tube covered by the holder.

In this configuration, the discharge tube attaching member can be effectively held at each side of the elastic gripping member.

The rib included in the holder may be in contact with the main body of the discharge tube attaching member at a plurality of locations of the rib, with the curved portion of the discharge tube covered by the holder.

In this configuration, because the plurality of locations of the rib is in contact with the main body of the discharge tube attaching member, the discharge tube attaching member can be effectively held.

The rib included in the holder may have a blunt distal portion.

In this configuration, because the distal end of the rib is in surface contact with the main body of the holder, the rib abutted on the main body of the discharge tube attaching member can be stabilized.

The rib included in the holder may have a shape tapering toward the main body of the discharge tube attaching member, with the curved portion of the discharge tube covered by the holder. In this case, the rib of the holder may have a substantially conical shape. Alternatively, the rib of the holder may have a substantially pyramidal shape.

In this configuration, because the distal end of the rib is in point contact with the main body of the discharge tube attaching member, the distal end of the rib can be in contact with the main body of the discharge tube attaching member without being interfered by the curved portion of the discharge tube. Therefore, the distal end of the rib can be easily in contact with the main body.

The rib included in the holder may include two plates intersecting with each other at a right angle, and the two plates may protrude in the holder toward the main body of the discharge tube attaching member, with the curved portion of the discharge tube covered by the holder.

In this configuration, the rib has a cross-shaped cross section. Therefore, the rib abutted on the main body of the discharge tube attaching member can be effectively stabilized.

The rib included in the holder may have a plate-like shape curved in a direction perpendicular to a direction in which the rib extends, the rib may protrude in the holder toward the main body of the discharge tube attaching member, with the curved portion of the discharge tube covered by the holder.

In this configuration, because the rib has a curved cross sectional shape, the rib abutted on the main body of the discharge tube attaching member can be effectively stabilized.

The rib of the holder may have a cylindrical shape protruding in the holder toward the main body of the discharge tube attaching member, with the curved portion of the discharge tube covered by the holder.

In this configuration, the rib has a ring-shaped cross section. Therefore, the rib abutted on the main body of the discharge tube attaching member can be effectively stabilized.

The rib of the holder may include a two-pronged distal portion.

In this configuration, the rib can be in contact with the main body of the holder at least two points of the rib. Therefore, the stability of the rib in contact with the main body of the holder can be increased.

The rib of the holder may have an arch-like shape with two legs, and the discharge tube may pass between the legs of the rib, with the curved portion of the discharge tube covered by the holder.

In this configuration, because the rib has an arch-like shape, the discharge tube can pass between the legs of the rib.

The legs of the holder having the arch-like shape may each include a bottom surface that is in contact with the main body of the discharge tube attaching member, with the curved portion of the discharge tube covered by the holder.

In this configuration, because the rib has an arch-like shape and the bottom surface of each of the legs is in contact with the main body of the discharge tube attaching member, the discharge tube attaching member can be held by the legs of the rib. Therefore, the discharge tube attaching member can be effectively held.

The elastic gripping member of the discharge tube attaching member may grip the curved portion of the tube of the discharge tube by sandwiching the curved portion from both sides thereof.

In this configuration, the curved portion of the tube of the discharge tube can be effectively gripped by the elastic gripping member of the discharge tube attaching member.

The elastic gripping member of the discharge tube attaching member may grip a middle portion of the curved portion of the discharge tube.

In this configuration, the curved portion of the tube of the discharge tube can be gripped by the elastic gripping member of the discharge tube attaching member in a balanced manner.

The main body of the discharge tube attaching member may have a plate-like shape.

In this configuration, the main body of the discharge tube attaching member can be easily attached to the bottom surface of the chassis.

The main body of the discharge tube attaching member may have a truncated pyramidal shape.

In this configuration, compared with the case where the main body of the discharge tube attaching member has a plate-like shape, the thickness of the main body can be increased. Therefore, the main body can be attached to the bottom plate of the chassis in a stable manner.

The main body of the discharge tube attaching member may include a recess in which the rib is inserted. Alternatively, the rib included in the holder may include a recess in a bottom surface thereof, and the main body of the discharge tube attaching member may include a protrusion inserted into the recess of the rib.

In this configuration, the rib can be fixed onto the main body of the discharge tube attaching member. Therefore, the rib in contact with the main body can be hardly separated from the main body.

The discharge tube housed in the chassis may include a plurality of discharge tubes, and the discharge tube attaching member attached to the bottom surface of the chassis may include a plurality of discharge tube attaching members, and the holder may cover curved portions of tubes of the discharge tubes.

In this configuration, the plurality of discharge tubes can be housed in the chassis, and the curved portions of the discharge tubes can be gripped by the plurality of discharge tube attaching members.

The holder may include a cutout through which the discharge tube passes, with the curved portion of the discharge tube covered by the holder.

In this configuration, the discharge tube can be passed through the cutout of the holder.

The holder may have a side edge that is in contact with the bottom surface of the chassis, with the curved portion of the discharge tube covered by the holder.

In this configuration, the holder can be placed on the bottom surface of the chassis by abutting the side edge of the holder on the bottom surface of the chassis.

The discharge tube may be a U-shaped tube. Alternatively, the discharge tube may have a square U shape in a plan view. Alternatively, the discharge tube may have a meandering shape. In this case, the discharge tube may be an S-shaped tube. Alternatively, the discharge tube may be an L-shaped tube.

In these configurations, even when discharge tubes of various shapes are attached, transmission of the stress generated in the elastic gripping member to the discharge tubes can be prevented or suppressed. Therefore, the breaking of the discharge tubes can be prevented or suppressed.

The technology disclosed in the present description may be implemented as a display device including a display panel configured to provide display using light from the lighting device. A novel and useful display device is also provided when the display panel is a liquid crystal panel using liquid crystal. A television device including the display device is also novel and useful. According to the display device and the television, a display area can be increased.

### Advantageous Effect of the Invention

According to the technology disclosed in the present specification, a lighting device can be provided such that the breaking of a discharge tube can be prevented or suppressed when an elastic gripping member of a discharge tube attaching member is elastically deformed.

### BRIEF DESCRIPTION OF THE DRAWINGS

FIG. 1 is an exploded perspective view of a television device TV according to a first embodiment;

FIG. 2 is an exploded perspective view of a liquid crystal display device 10;

FIG. 3 is a plan view of a backlight unit 24 viewed from the front side;

FIG. 4 is a cross sectional view of the backlight unit 24 before a first holder 20 is attached, taken along the vertical direction;

FIG. 5 is a cross sectional view taken along a line A-A in FIG. 4;

FIG. 6 is a cross sectional view corresponding to FIG. 4 after the first holder 20 is attached;

FIG. 7 is a cross sectional view taken along a line B-B in FIG. 6;

FIG. 8 is an enlarged perspective view of curved portions 28b of discharge tubes 28 after the first holder 20 is attached, as viewed from diagonally above;

FIG. 9 is a plan view of a backlight unit 124 according to a second embodiment, as viewed from the front side;

FIG. 10 is an enlarged perspective view of curved portions 128b of discharge tubes 128 after a first holder 120 is attached, as viewed from diagonally above;

FIG. 11 is a plan view of a backlight unit 224 according to a third embodiment, as viewed from the front side;

FIG. 12 is an enlarged perspective view of curved portions 228b of discharge tubes 228 after a first holder 220 is attached, as viewed from diagonally above;

FIG. 13 is a plan view of a backlight unit 324 according to a fourth embodiment, as viewed from the front side;

FIG. 14 is an enlarged perspective view of a curved portion 328b of discharge tubes 328 after a first holder 320 is attached, as viewed from diagonally above;

FIG. 15 is an enlarged cross sectional view according to a fifth embodiment, corresponding to FIG. 5 for the first embodiment;

FIG. 16 is an enlarged cross sectional view according to the fifth embodiment, corresponding to FIG. 7 for the first embodiment;

FIG. 17 is an enlarged cross sectional view according to a sixth embodiment, corresponding to FIG. 5 for the first embodiment;

FIG. 18 is an enlarged cross sectional view according to the sixth embodiment, corresponding to FIG. 7 for the first embodiment;

FIG. 19 is an enlarged perspective view of curved portions 628b of discharge tubes 628 after a first holder 620 is attached according to the seventh embodiment, as viewed from diagonally above; and

FIG. 20 is an enlarged perspective view of curved portions 728b of discharge tubes 728 after a first holder 720 is attached according to the eighth embodiment, as viewed from diagonally above.

### BEST MODE FOR CARRYING OUT THE INVENTION

### First Embodiment

With reference to the drawings, a first embodiment will be described. In some of the drawings, an X-axis, a Y-axis, and a Z-axis are shown, the respective axial directions being common throughout the drawings. The Y-axis direction is aligned with the vertical direction, and the X-axis direction is aligned with the horizontal direction. References to “up” and “down” correspond to the vertical direction unless otherwise specified.

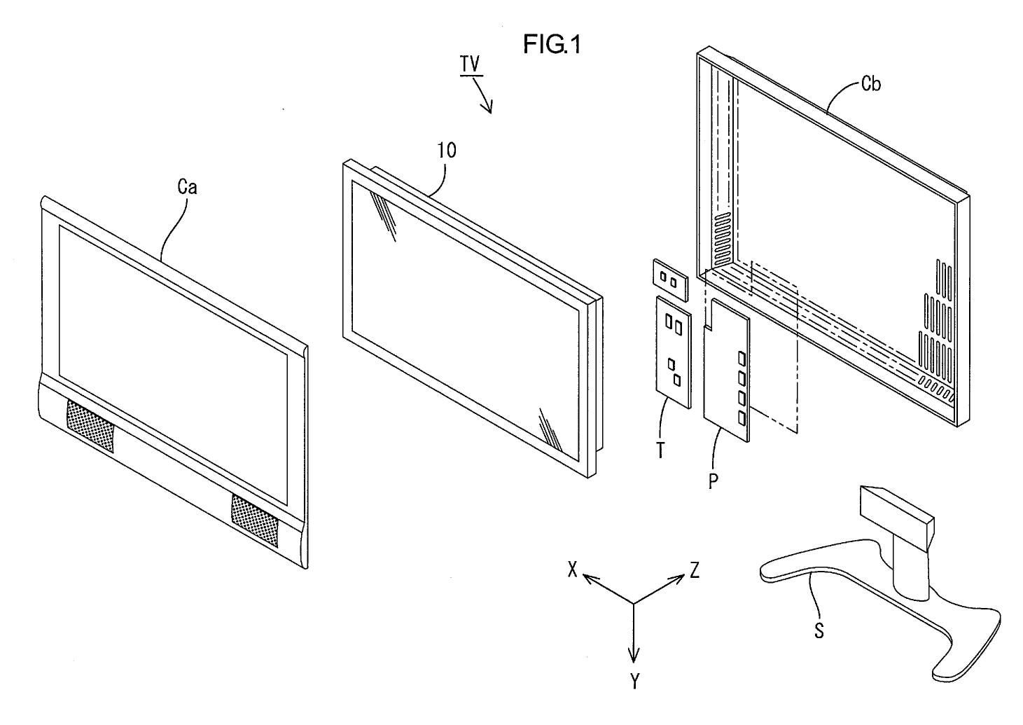

FIG. 1 is an exploded perspective view of a television device TV according to a first embodiment. The television device TV includes a liquid crystal display device 10, front and rear cabinets Ca and Cb housing the display device D in a sandwiched manner, a power source P, a tuner T, and a stand S.

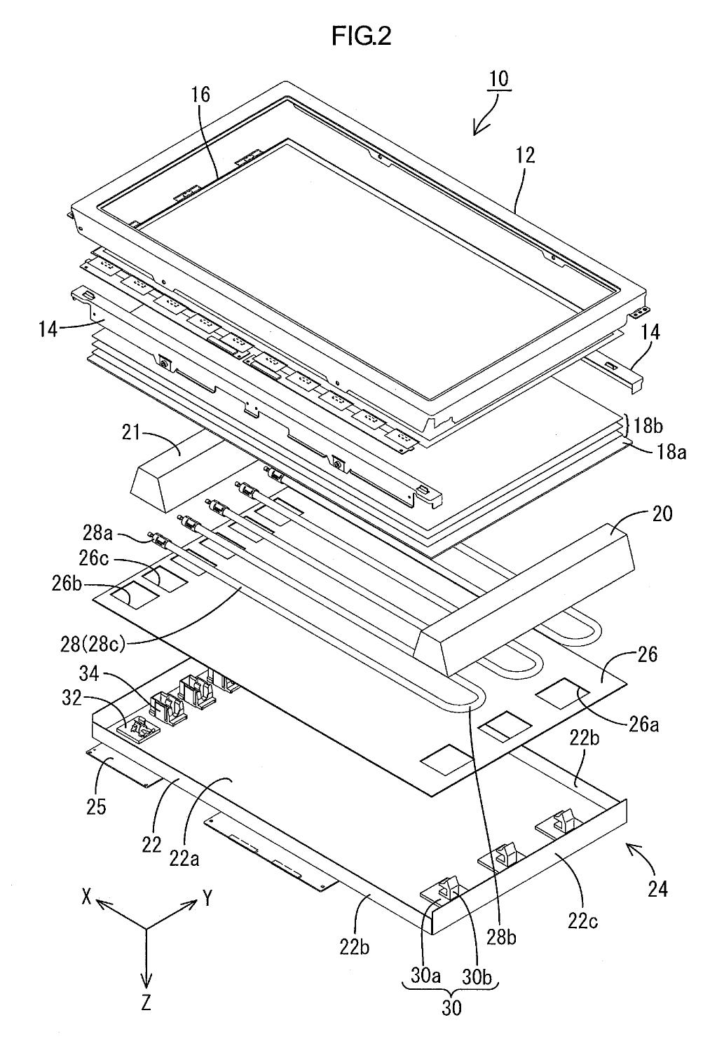

FIG. 2 is an exploded perspective view of the liquid crystal display device 10. The top and bottom of FIG. 2 correspond to a front side and a rear side, respectively. As shown in FIG. 2, the liquid crystal display device 10 has a horizontally long square shape as a whole. The liquid crystal display device 10 includes a liquid crystal panel 16 as a display panel, and a backlight unit 24 as an external light source, which are integrally held by a frame-shaped bezel 12, and the like.

The liquid crystal panel 16 will be described. The liquid crystal panel 16 includes a pair of transparent (highly light transmissive) glass substrates affixed to each other via a predetermined gap, with a liquid crystal layer (not shown) enclosed between the glass substrates. The glass substrates has switching components (for example, TFTs) connected to a source wiring and a gate wiring, which are orthogonal to each other, pixel electrodes connected to the switching components, an alignment film, and the like. The other glass substrate has a color filter including color sections of, for example, R (red), G (green), and B (blue) in a predetermined arrangement, counter electrodes, an alignment film, and the like. The source wiring, the gate wiring, the counter electrodes and the like are supplied with image data or various control signals necessary for displaying an image from a drive circuit board, which is not shown. On the outside of the glass substrate, a polarizing plate (not shown) is disposed.

The backlight unit 24 will be described. As shown in FIG. 2, the backlight unit 24 includes frames 14, optical members 18, and a backlight chassis 22. The backlight chassis 22 has a substantially box-like shape with an opening on the front side (light output side; facing the liquid crystal panel 16). Specifically, the backlight chassis 22 is made of metal, such as an aluminum material, and includes a bottom plate 22a with a rectangular shape in a plan view, side plates 22b rising from the outer edges of the bottom plate 22a on the long sides thereof, and side plates 22c rising from the outer edges of the bottom plate 22a on the short sides thereof. The frames 14 have a rectangular shape and support the liquid crystal panel 16 along the inner edges of the frames 14. The optical members 18 are disposed on the front side of discharge tubes 28.

The optical members 18 include a diffuser plate 18a. The diffuser plate 18a is a synthetic resin plate in which light scattering particles are dispersed. The diffuser plate 18a has a function of diffusing light emitted by the discharge tubes 28, and also a function of reflecting the output light from the discharge tubes 28. Optical sheets 18b disposed on the front side of the diffuser plate 18a include a diffuser sheet, a lens sheet, and a reflection type polarizing plate stacked in order from the diffuser plate 18a. The optical sheets 18b have a function of converting the light emitted from the discharge tubes 28 and passed through the diffuser plate 18a into planar light. On the front side of the optical sheets 18b, the liquid crystal panel 16 is disposed. The optical sheets 18b are sandwiched between the diffuser plate 18a and the liquid crystal panel 16.

The backlight chassis 22 houses (on the front side of the bottom plate 22a of the backlight chassis 22) a reflection sheet 26, three discharge tubes 28, and a pair of holders (a first holder 20 and a second holder 21). On the bottom plate 22a of the backlight chassis 22, three lamp clips 30 are disposed at equal intervals along one of the side edges (on the right side in FIG. 2) in the short side direction (Y-axis direction). Along the other side edge (on the left side in FIG. 2) in the short side direction (Y-axis direction), two grounding terminals 32 and four relay connectors 34 are disposed at equal intervals. The configuration of the lamp clips 30 will be described in detail later.

The relay connectors 34 and the grounding terminals 32 are attached to the bottom plate 22a of the backlight chassis 22 through the bottom plate 22a. The relay connectors 34 are connected to a power supply board 25 disposed on the rear side of the bottom plate 22a of the backlight chassis 22. The power supply board 25 is a circuit for supplying electric power to the discharge tubes and includes a transformer (not shown). The grounding terminals 32 are electrically connected to the backlight chassis 22 on the rear side of the backlight chassis 22.

The reflection sheet 26 is made of synthetic resin with a white surface for excellent optical reflectivity, and laid along the surface of the bottom plate 22a of the backlight chassis 22 so as to cover substantially the entire area of the surface. The reflection sheet 26 is configured to reflect the light emitted from the discharge tubes 28 toward the diffuser plate 18a. The reflection sheet 26 includes openings 26a, 26b, and 26c at positions overlapping with the lamp clips 30, the grounding terminals 32, and the relay connectors 34, respectively, which are attached to the bottom plate 22a of the backlight chassis 22. With the reflection sheet 26 laid on the surface of the bottom plate 22a, the lamp clips 30, the relay connectors 34, and the grounding terminals 32 are exposed on the front side of the reflection sheet 26 through the openings 26a, 26b, and 26c.

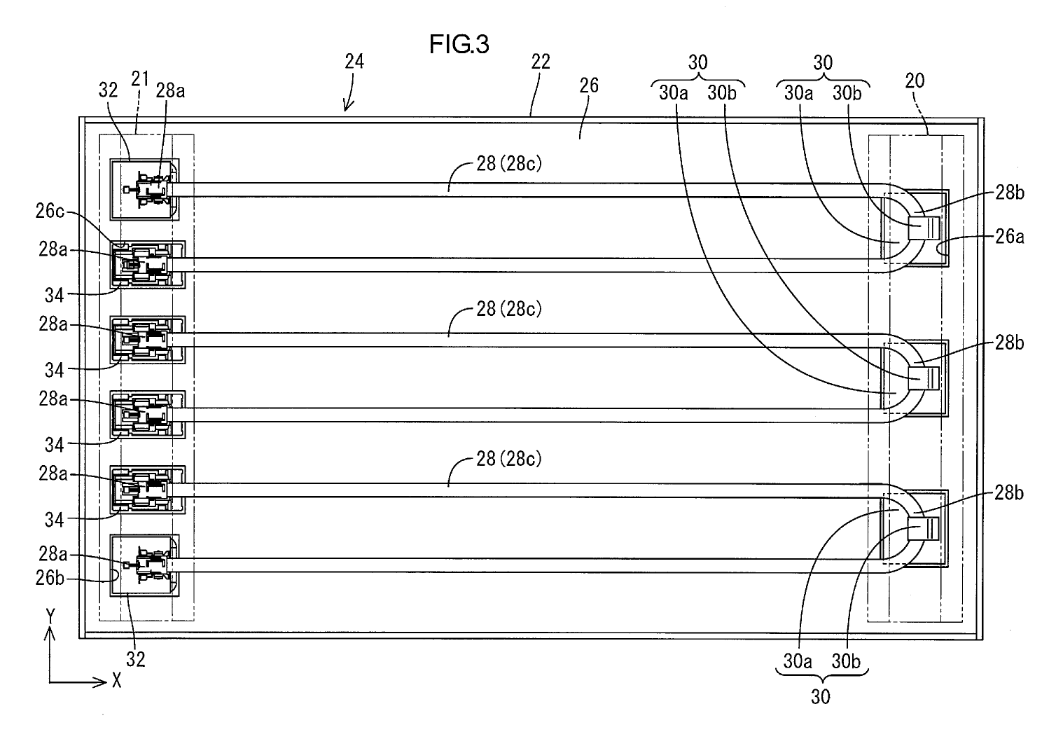

FIG. 3 is a plan view of the backlight unit 24 as viewed from the front side. The three discharge tubes 28 are cold cathode tubes and include a tube portion 28c; a pair of electrodes 28a disposed at the end portions of the tube portion 28c; and a curved portion 28b at which the tube portion 28c is bent in the U shape such that the pair of electrodes 28a are oriented in the same direction. As shown in FIG. 3, the discharge tubes 28 are housed in the backlight chassis 22 with the axial direction of the tube portion 28c aligned with the long side direction of the backlight chassis 22 (X-axis direction). The discharge tubes 28 are arranged side by side at predetermined intervals along the short side direction of the backlight chassis 22 (Y-axis direction). The discharge tubes 28 are arranged at substantially regular intervals or pitch.

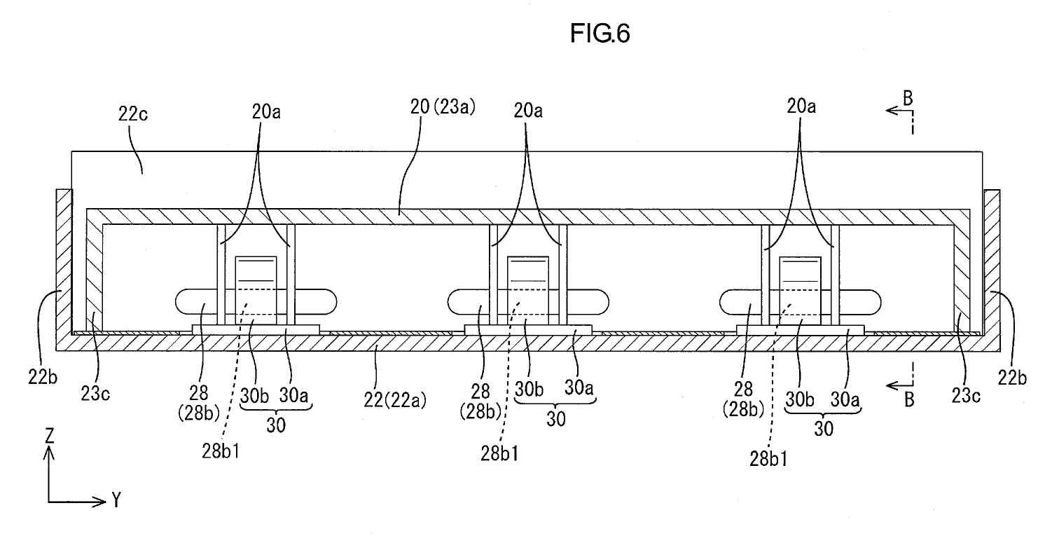

The curved portion 28b of the discharge tubes 28 has a middle portion 28b1 (see FIG. 6) attached to the lamp clips 30 mounted on the bottom plate 22a of the backlight chassis 22. The distal portion of the electrodes 28a at the end portions of the discharge tubes 28 is ferruled. The ferruled distal portion is fitted in, and thereby electrically connected to, the relay connectors 34 or the grounding terminals 32 on the bottom plate 22a of the backlight chassis 22. Thus, the discharge tubes 28 are slightly floated above the bottom plate 22a of the backlight chassis 22 and the reflection sheet 26. According to the present embodiment, in a plan view of the backlight unit 24, of the electrodes 28a of the three discharge tubes 28, the inner four of the electrodes 28a of the three discharge tubes 28 are connected to the relay connectors 34, and the outer two electrodes 28a are connected to the grounding terminals 32. Because the backlight chassis 22 is made of metal and grounded, the electrodes 28a connected to the grounding terminals 32 are maintained at ground potential.

Of the pair of holders 20 and 21, the first holder 20 covers the curved portion 28b of the discharge tubes 28, while the second holder 21 covers the end portions (electrodes 28a) of the discharge tubes 28. The holders 20 and 21 are made of white synthetic resin and have a long, substantially box-like shape extending along the short side direction of the backlight chassis 22 (Y-axis direction). The holders 20 and 21 include an upper surface on which the diffuser plate 18a and the liquid crystal panel 16 can be placed. The configuration of the first holder 20 will be described in detail later.

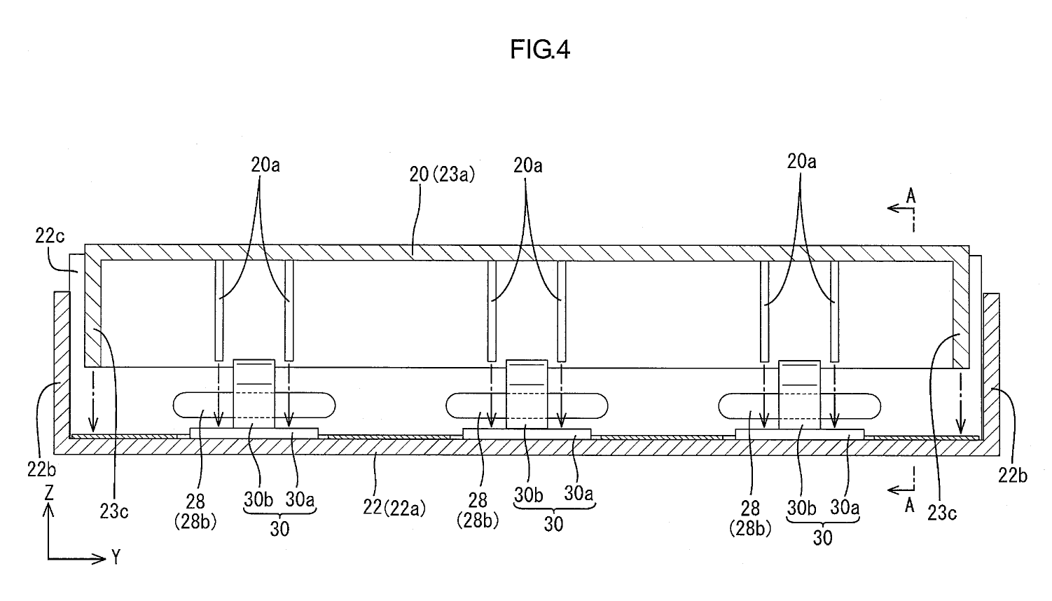

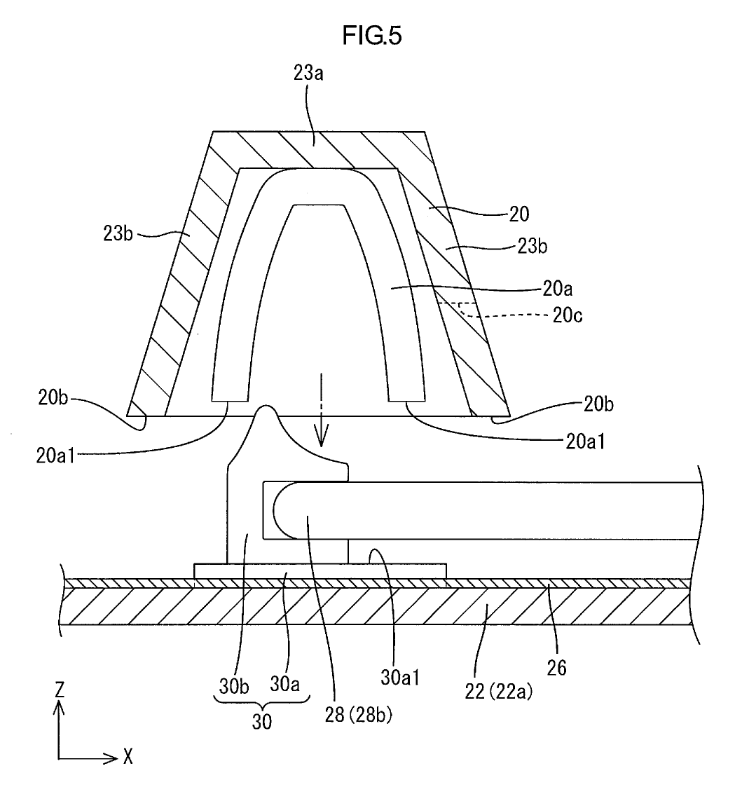

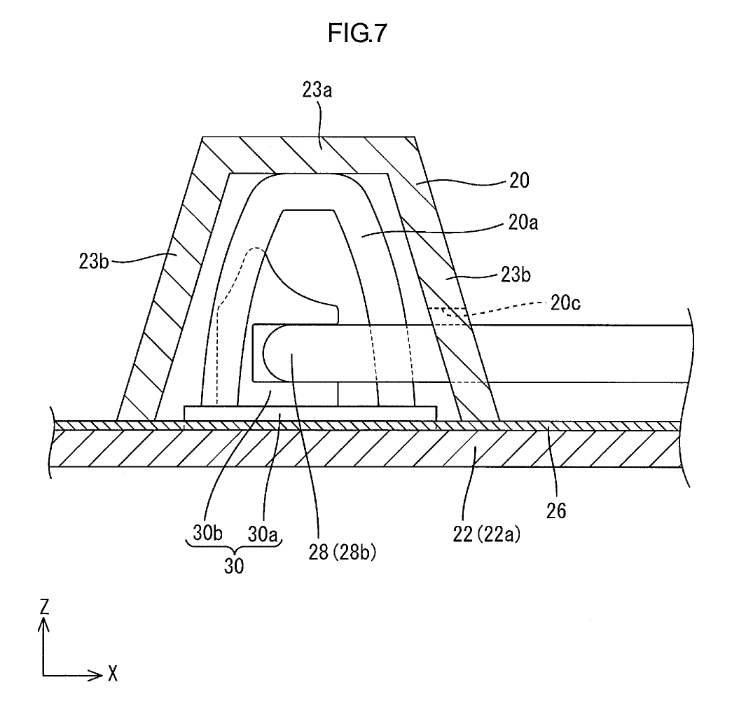

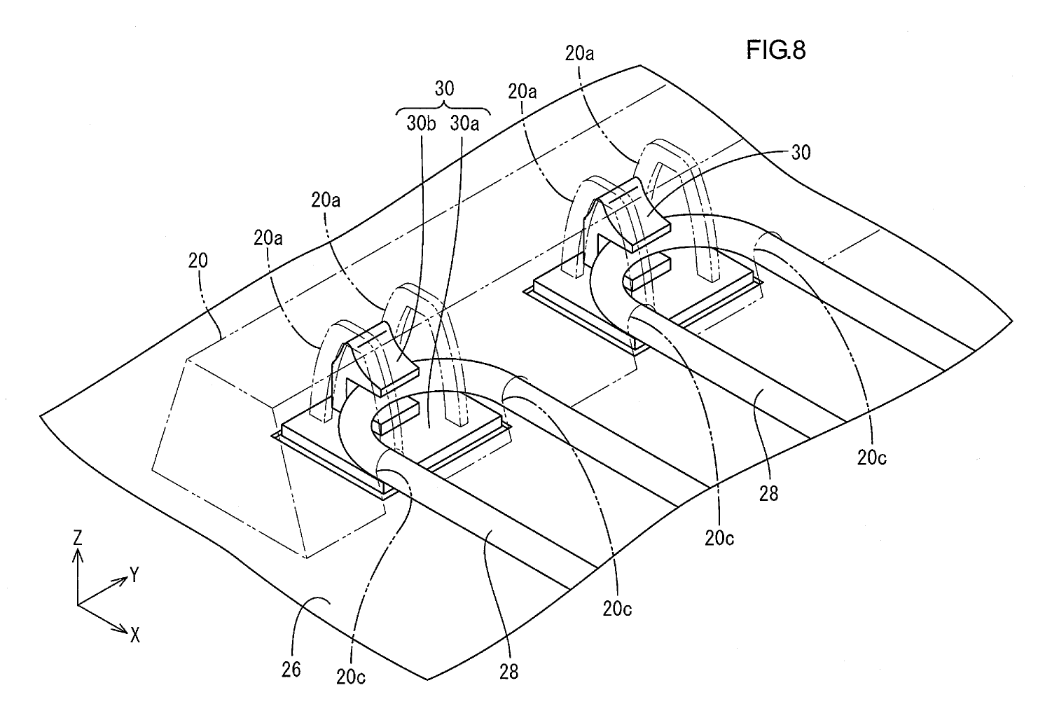

The configuration of the lamp clips 30 and the first holder 20 will be described. FIG. 4 is a cross sectional view of the backlight unit 24 before the first holder 20 is attached to the bottom plate 22a of the backlight chassis 22, taken along the vertical direction outside the lamp clips 30 (to the right of the lamp clips 30 in FIG. 3). FIG. 5 is a cross sectional view taken along a line A-A in FIG. 4, showing an enlarged cross sectional view of the curved portion 28b of the discharge tube 28 taken along the horizontal direction, before the first holder 20 is attached to the bottom plate 22a of the backlight chassis 22. FIG. 6 is across sectional view corresponding to the cross section of FIG. 4, after the first holder 20 is attached to the bottom plate 22a of the backlight chassis 22. FIG. 7 is a cross sectional view taken along a line B-B in FIG. 6, showing an enlarged cross sectional view of the curved portion 28b of the discharge tube 28 taken along the horizontal direction, after the first holder 20 is attached to the bottom plate 22a of the backlight chassis 22. FIG. 8 is an enlarged perspective view of the curved portions 28b of the discharge tubes 28 as viewed from diagonally above, after the first holder 20 is attached to the bottom plate 22a of the backlight chassis 22.

As shown in FIGS. 4 to 8, the lamp clips 30 include a main body 30a and a lamp rubber 30b. The main body 30a is made of synthetic resin (such as polycarbonate) and has white surface for excellent optical reflectivity. The main body 30a has a plate-like shape and is attached to the bottom plate 22a of the backlight chassis 22 with screws, and the like, the plane of the main body 30a extending along the bottom plate 22a. The lamp rubber 30b is made of rubber with white surface for excellent optical reflectivity. As shown in FIG. 5, for example, the lamp rubber 30b has a shape configured to sandwich the middle portion 28b1 of the curved portion 28b of the discharge tubes 28 from the front and rear sides (see FIG. 6). The curved portion 28b of the discharge tubes 28 is elastically gripped by the lamp rubber 30b when the middle portion 28b1 is attached onto the lamp rubber 30b laterally from the inner side of the lamp rubber 30b.

As shown in FIGS. 4 to 8, the first holder 20 has a substantially box-like shape and includes an upper surface 23a; a pair of first side walls 23b, 23b; and a pair of second side walls 23c, 23c. The upper surface 23 extends along the short side direction of the backlight chassis 22 (Y-axis direction) and is parallel with the bottom plate 22a. The pair of first side walls 23b, 23b extends from the ends of the upper surface 23 in the horizontal direction (X-axis direction) obliquely downward toward the bottom plate 22a of the backlight chassis 22. The pair of second side walls 23c, 23c extends from the ends of the upper surface 23 in the vertical direction (Y-axis direction) downward toward the bottom plate 22a of the backlight chassis 22. The second side walls 23c are parallel with the side walls 22b of the backlight chassis 22 on the long sides. The first side walls 23b and the second side walls 23c define a space inside the first holder 20 in which the curved portions 28b of the discharge tubes 28 and the lamp clips 30 can be housed.

Side edges 20b of the first side walls 23b and side edges of the second side walls 23c are flush with each other and parallel with the bottom plate 22a of the backlight chassis 22. The first side walls 23b or the second side walls 23c are provided with an attaching pin (not shown). The backlight chassis 22 is provided with an attaching hole (not shown), at a position corresponding to the attaching pin. By attaching the attaching pin of the first holder 20 in the attaching hole of the backlight chassis 22, the first holder 20 can be attached to the backlight chassis 22.

The first holder 20 has a plurality of plate-shaped ribs 20a extending from an inner side of the upper surface 23a (the side facing the bottom plate 22a of the backlight chassis 22) downwardly. The ribs 20a are arch-shaped with their planar surfaces parallel with the side walls 22b of the backlight chassis 22b on the long sides (see FIGS. 5, 7, and 8). Thus, each of the ribs 20a has two legs extending downward. The lower ends of the two legs of each of the ribs 20a are positioned at the same height, with bottom surfaces 20a1 of the lower ends parallel with the bottom plate 22a of the backlight chassis 22.

The bottom surfaces 20a1 of the two legs of each of the ribs 20a are positioned slightly higher than the side edges 20b of the first side walls 23b (by the thickness of the main body 30a of the lamp clips 30). The distance between the two legs of each of the ribs 20a is smaller than the width of the main body 30a of the lamp clips 30 in the horizontal direction (X-axis direction) and greater than the diameter of the discharge tube 28. On the other hand, the distance between the side edges 20b, 20b of the facing pair of first side walls 23b, 23b is greater than the width of the main body 30a of the lamp clips 30 in the horizontal direction (X-axis direction). Thus, when the first holder 20 is abutted on the bottom plate 22a of the backlight chassis 22 (reflection sheet 26) such that the main body 30a of the lamp clips 30 is positioned between the side edges 20b, 20b of the pair of first side walls 23b, 23b, the bottom surfaces 20a1 of the two legs of each of the ribs 20a are abutted on the surface 30a1 of the main body 30a of the lamp clips 30 (see FIG. 7).

The lamp clips 30 are prevented from loosening and held by the ribs 20a as the main body 30a is abutted on the ribs 20a of the first holder 20. Because the distance between the two legs of each of the ribs 20a is greater than the diameter of the discharge tube 28, the discharge tubes 28 can pass between the two legs of each of the ribs 20a when the lamp clips 30 are held by the first holder 20 (see FIG. 8).

The ribs 20a are disposed in three pairs along the Y-axis direction such that the first holder 20 is positioned on both sides of the lamp rubber 30b of the lamp clips 30 in the Y-axis direction. Thus, a pair of ribs 20a is provided for each of the discharge tubes 28. The two legs of each of the ribs 20a are configured to be abutted on the main body 30a of the lamp clips 30. Accordingly, the main body 30a of the lamp clips 30 is abutted on the pair of ribs 20a and thereby held at four points.

The distance between the pair of ribs 20a is greater than the width of the lamp rubber 30b of the lamp clips 30 in the vertical direction (Y-axis direction). When the legs of the pair of ribs 20a are abutted on the main body 30a of the lamp clips 30, the pair of ribs 20a is spaced apart from the lamp rubber 30b (see FIG. 6).

Further, as shown in FIG. 8, in the side edge 20b of the inner one of the first side walls 23b, cutouts 20c are formed (not shown in FIGS. 4 and 6). The cutouts 20c have a width greater than the diameter of the discharge tube 28. Thus, when the lamp clips 30 are held by the first holder 20, the discharge tubes 28 can be passed through the cutouts 20c. Accordingly, the curved portion 28b of the discharge tubes 28 can be covered by the first holder 20 without being interfered by the discharge tubes 28. While not shown in FIG. 2, the second holder 21 also includes similar cutouts such that the electrodes 28a of the discharge tubes 28 can be covered by the second holder 21 without being interfered by the discharge tubes 28.

When attaching the first holder 20 to the bottom plate 22a of the backlight chassis 22, the first holder 20 is positioned over the lamp rubbers 30b of the lamp clips 30 to which the curved portions 28b of the discharge tubes 28 are attached, such that the lamp rubber 30b is positioned between the pair of ribs 20a (see FIGS. 4 and 5). Then, the first holder 20 is lowered from this position. As the discharge tubes 28 pass between the two legs of each of the ribs 20a, the bottom surfaces 20a1 of the two legs of each of the ribs 20a are abutted on the main body 30a of the lamp clips 30. At the same time, the side edges 20b of the first side walls 23b and the side edges of the second side walls 23c of the first holder 20 are abutted on the bottom plate 22a of the backlight chassis 22 (reflection sheet 26). Thus, the curved portions 28b of the discharge tubes 28 and the lamp clips 30 are covered by the first holder 20 as the first holder 20 is attached to the bottom plate 22a of the backlight chassis 22.

Because the bottom surfaces 20a1 of the two legs of each of the ribs 20a are abutted on the main body 30a of the lamp clips 30, the lamp clips 30 can be held by the ribs 20a such that the loosening of the lamp clips 30 due to vibration of the discharge tubes 28 can be prevented or suppressed. The lamp rubber 30b is spaced apart from the ribs 20a. Thus, even when the lamp rubber 30b is elastically deformed by heat and the like, freedom of the lamp rubber 30b can be ensured such that the stress produced in the lamp rubber 30b by elastic deformation can be released to the outside.

Thus, in the backlight unit 24 according to the present embodiment, when the curved portions 28b of the discharge tubes 28 are covered by the first holder 20, the lamp clips 30 are held via the main bodies 30a by the ribs 20a of the first holder 20, while the lamp rubbers 30b of the lamp clips 30 are not regulated. Accordingly, when the lamp rubber 30b of the lamp clip 30 is elastically deformed while the curved portion 28b of the discharge tube 28 is covered by the first holder 20 and the lamp clip 30 are held, the stress generated in the lamp rubber 30b can be released. In this way, the stress generated in the lamp rubber 30b can be prevented or suppressed from being transmitted to the discharge tube 28. Therefore, the breaking of the discharge tube 28 can be prevented or suppressed.

Further, in the backlight unit 24 according to the present embodiment, the first holder 20 is provided with the plurality of ribs 20a. When the curved portions 28b of the discharge tubes 28 are covered by the first holder 20, the plurality of ribs 20a is abutted on the main body 30a of the lamp clips 30. Thus, the lamp clips 30 can be effectively held by the plurality of ribs 20a abutting on the main body 30a of the lamp clips 30.

Further, in the backlight unit 24 according to the present embodiment, when the curved portions 28b of the discharge tubes 28 are covered by the first holder 20, the plurality of ribs 20a of the first holder 20 is disposed on both sides of the lamp rubber 30b of the lamp clip 30. Thus, the lamp clips 30 can be effectively held on both sides of the lamp rubber 30b.

Further, in the backlight unit 24 according to the present embodiment, when the curved portions 28b of the discharge tubes 28 are covered by the first holder, the ribs 20a of the first holder 20 are abutted on the main body 30a of the lamp clips 30 at two locations of the ribs 20a. Thus, because the ribs 20a are abutted on the main body 30a of the lamp clips 30 at two locations, the lamp clips 30 can be effectively held.

Further, in the backlight unit 24 according to the present embodiment, the ribs 20a of the first holder 20 are arch-shaped with two legs, and the discharge tubes 28 pass between the legs when the curved portions 28b of the discharge tubes 28 are covered by the first holder 20. Thus, because the ribs 20a are arch-shaped, the discharge tubes 28 can pass between the legs.

Further, in the backlight unit 24 according to the present embodiment, the arch-shaped ribs 20a are configured such that, when the curved portions 28b of the discharge tubes 28 are covered by the first holder 20, the bottom surfaces 20a1 of the legs are abutted on the main body 30a of the lamp clips 30. Thus, because the ribs 20a are arch-shaped and the bottom surfaces 20a1 of the legs are abutted on the main body 30a of the lamp clips 30, each of the lamp clips 30 can be held by both legs of the ribs 20a. Therefore, the lamp clips 30 can be effectively held.

Further, in the backlight unit 24 according to the present embodiment, the lamp rubber 30b of the lamp clip 30 is configured to grip the curved portion 28b by sandwiching the curved portion 28b of the discharge tube 28 from both sides thereof. Thus, the curved portion of the discharge tube 28 can be effectively gripped by the lamp rubber 30b of the lamp clip 30.

Further, in the backlight unit 24 according to the present embodiment, the lamp rubber 30b of the lamp clip 30 is configured to grip the middle portion of the curved portion 28b of the discharge tube 28. Thus, the curved portion 28b of the discharge tube 28 can be gripped by the lamp rubber 30b of the lamp clips 30 in a balanced manner.

Further, in the backlight unit 24 according to the present embodiment, the main body 30a of the lamp clip 30 has a plate-like shape. Thus, the main body 30a of the lamp clips 30 can be easily attached to the bottom plate 22a of the backlight chassis 22.

Further, in the backlight unit 24 according to the present embodiment, the three discharge tubes 28 are housed in the backlight chassis 22; the three lamp clips 30 are attached to the bottom plate 22a of the backlight chassis 22; and the curved portions 28b of the three discharge tubes 28 are covered by the holder 20. Thus, the three discharge tubes 28 can be housed in the backlight chassis 22, and the curved portions 28b of the discharge tubes 28 can be gripped by the three lamp clips 30.

Further, in the backlight unit 24 according to the present embodiment, the first holder 20 is provided with the cutouts 20c through which the discharge tubes 28 can pass when the curved portions 28b of the discharge tubes 28 are covered by the first holder 20. Thus, the discharge tubes 28 can pass through the cutouts 20c of the first holder 20.

Further, in backlight unit 24 according to the present embodiment, the first holder 20 is configured such that, when the curved portions 28b of the discharge tubes 28 are covered by the first holder 20, the side edges 20b are abutted on the bottom plate 22a of the backlight chassis 22. Thus, the first holder 20 can be placed on the bottom plate 22a of the backlight chassis 22 by abutting the side edges of the first holder 20 on the bottom plate 22a of the backlight chassis 22.

### Second Embodiment

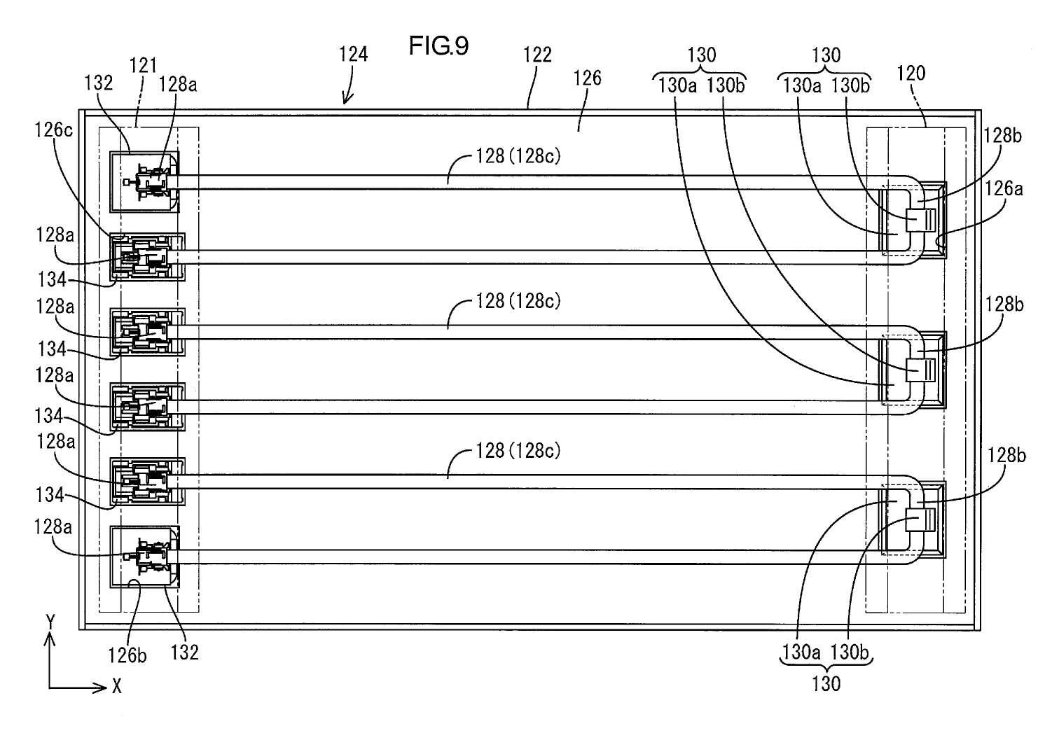

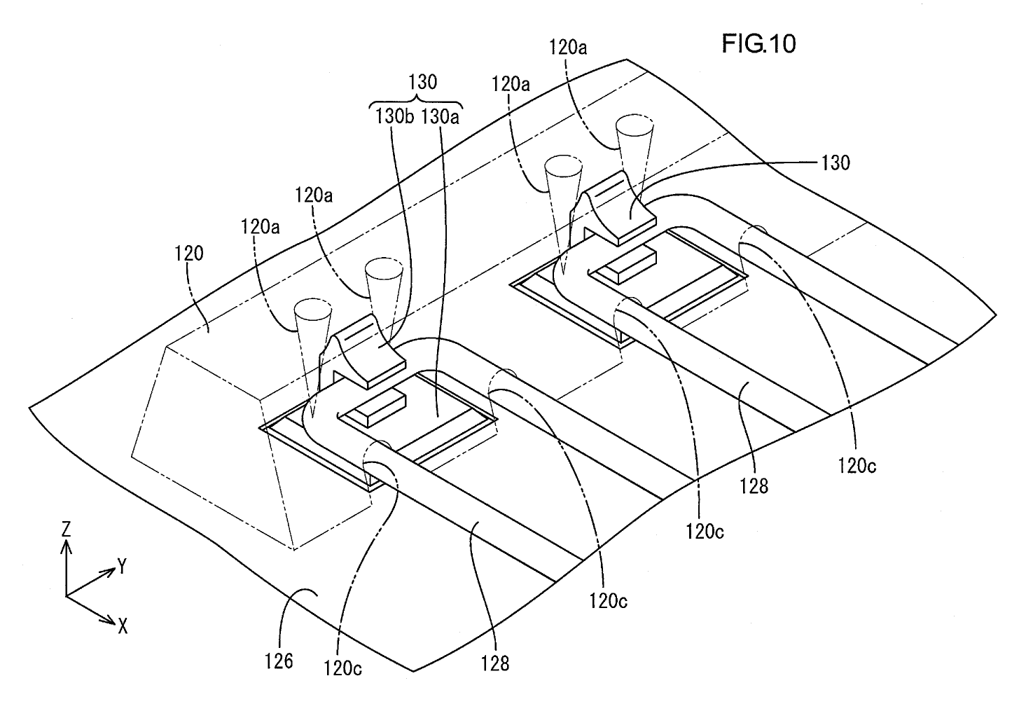

With reference to the drawings, a second embodiment will be described. FIG. 9 is a plan view of a backlight unit 124 according to the second embodiment. FIG. 10 is an enlarged perspective view of curved portions 128b of discharge tubes 128 after a first holder 120 is attached, as viewed from diagonally above. The second embodiment differs from the first embodiment in the shape of the discharge tubes 128 and the shape of ribs 120a. In FIGS. 9 and 10, portions designated by adding the number 100 to the reference numerals shown in FIGS. 3 and 8 are identical to the corresponding portions described with reference to the first embodiment.

In the backlight unit 124 according to the second embodiment, as shown in FIG. 9, the discharge tubes 128 housed in the backlight chassis 122 have a square U shape in a plan view. A middle portion of the square U shaped curved portions 128b of the discharge tubes 128 is gripped by a lamp rubber 130b. Even when the discharge tube 128 has such a shape, transmission of the stress generated in the lamp rubber 130b to the discharge tube 128 can be prevented or suppressed. Therefore, the breaking of the discharge tube 128 can be prevented or suppressed.

In the backlight unit 124 according to the second embodiment, as shown in FIG. 10, the first holder 120 includes ribs 120a with a conical shape which becomes thinner toward a main body 130a of lamp clips 130. Thus, the distal ends of the ribs 120a are abutted on the main body 130a of the lamp clips 130 through point contact. Accordingly, the distal ends of the ribs 120a can be abutted on the main bodies 130a of the lamp clips 130 without being interfered by the curved portions 128b of the discharge tubes 128. In this way, according to the present embodiment, the distal ends of the ribs 120a can be easily abutted on the main body 130a of the lamp clips 130.

### Third Embodiment

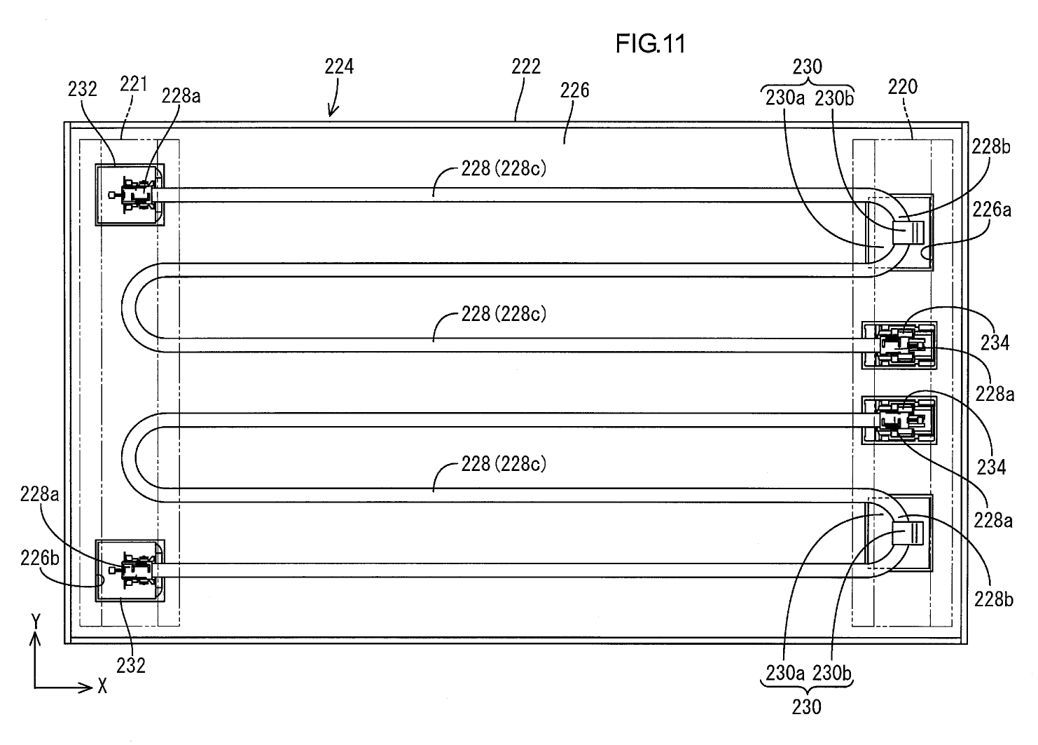

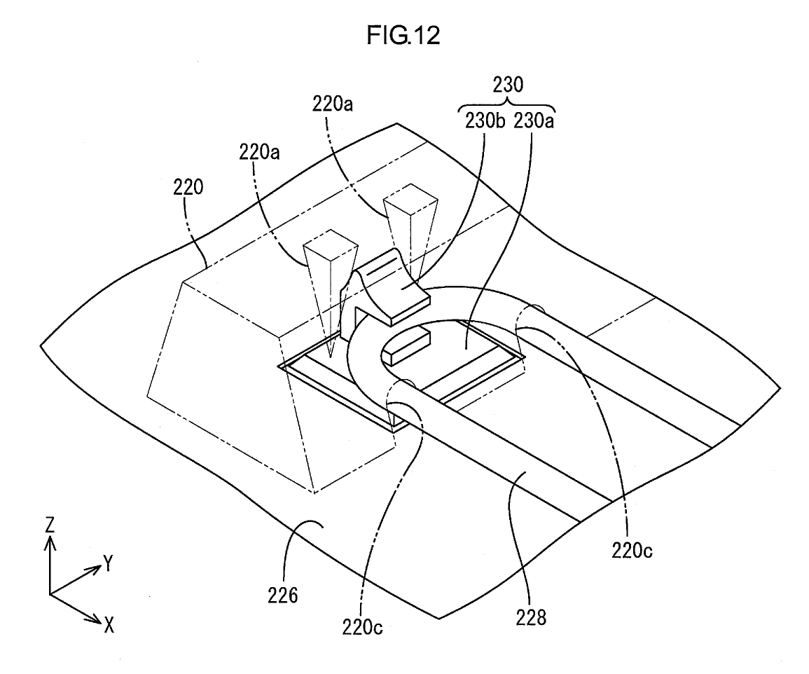

With reference to the drawings, a third embodiment will be described. FIG. 11 is a plan view of a backlight unit 224 according to the second embodiment. FIG. 12 is an enlarged perspective view of a curved portion 228b of discharge tube 228 after a first holder 220 is attached, as viewed from diagonally above. The third embodiment differs from the first embodiment in the shape of the discharge tubes 228 and the shape of ribs 220a. In FIGS. 11 and 12, portions designated by adding the number 200 to the reference numerals shown in FIGS. 3 and 8 are identical to the corresponding portions described with reference to the first embodiment.

In the backlight unit 224 according to the third embodiment, as shown in FIG. 11, the discharge tube 228 housed in a backlight chassis 222 has an S shape in a plan view. A middle portion of a curved portion 228b of the S shaped discharge tube 228 is gripped by a lamp rubber 130b. Even when the discharge tubes 228 have such shape, transmission of the stress generated in the lamp rubber 230b to the discharge tubes 228 can be prevented or suppressed. Therefore, the breaking of the discharge tubes 228 can be prevented or suppressed.

In the backlight unit 224 according to the third embodiment, as shown in FIG. 12, the ribs 120a of the first holder 220 have a quadrangular pyramidal shape which becomes thinner toward a main body 230a of lamp clips 230. Thus, the distal ends of the ribs 220a are abutted on the main body 230a of the lamp clips 230 through point contact. Therefore, the distal ends of the ribs 220a can be abutted on the main body 130a of the lamp clips 230 without being interfered by the curved portion 128b of the discharge tubes 228. In this way, according to the present embodiment, the distal ends of the ribs 220a can be easily abutted on the main body 230a of the lamp clips 230.

### Fourth Embodiment

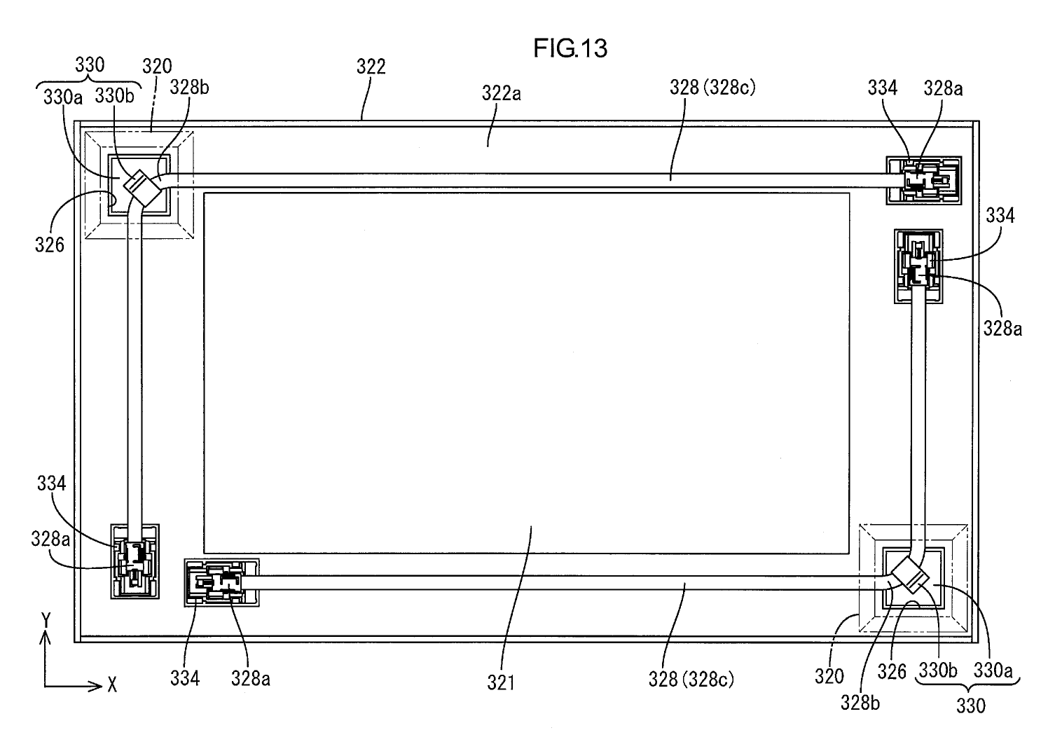

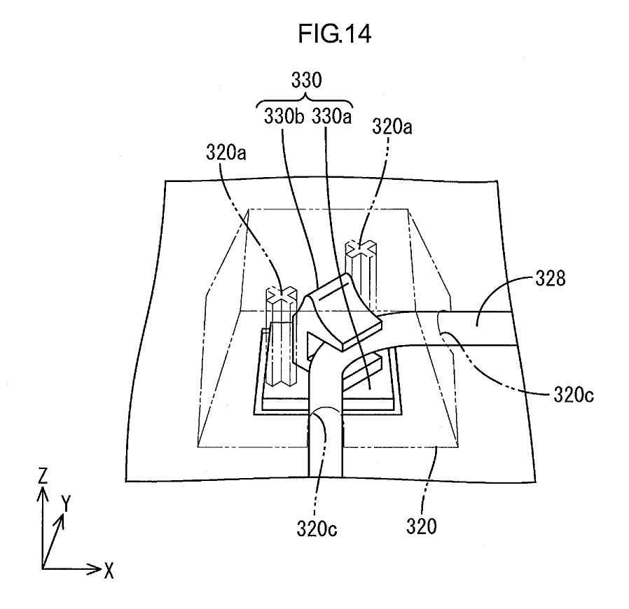

With reference to the drawings, a fourth embodiment will be described. FIG. 13 is a plan view of a backlight unit 324 according to the second embodiment. FIG. 14 is an enlarged perspective view of a curved portion 328b of a discharge tube 328 after a first holder 320 is attached, as viewed from diagonally above. The fourth embodiment differs from the first embodiment in the shape of the discharge tubes 328 and the shape of ribs 320a, and in that the backlight unit 324 is of edge light type. In FIGS. 13 and 14, the portions designated by adding the number 300 to the reference numerals shown in FIGS. 3 and 8 are identical to the corresponding portions described with reference to the first embodiment.

In the backlight unit 324 according to the fourth embodiment, as shown in FIG. 11, two L-shaped discharge tubes 328 are housed in a backlight chassis 322 along the outer edges of the backlight chassis 322. Each of the discharge tubes 328 includes a curved portion 328b which is gripped by a lamp rubber 330b of a lamp clip 330 and covered by the holder 320. At the middle portion of the backlight chassis 322 surrounded by the two L-shaped discharge tubes 328, a light guide plate 321 for guiding the light emitted from the discharge tubes 328 is housed. The backlight unit 324 according to the present embodiment is of the so-called edge light type (side light type) in which the light guide plate 321 and optical members are disposed immediately under the liquid crystal panel, with the discharge tubes 328 as light sources disposed at side end portions of the light guide plate 321. Even in this configuration, transmission of the stress generated in the lamp rubber 330b to the discharge tubes 328 can be prevented or suppressed according to the present embodiment. Therefore, the breaking of the discharge tubes 328 can be prevented or suppressed.

In the backlight unit 324 according to the fourth embodiment, as shown in FIG. 14, the holder 320 includes ribs 320a. The ribs 320a have the shape of two plates orthogonal to each other extending from an inner side of the first holder 320 toward a main body 330a of the lamp clip 330, with the curved portion 328b of the discharge tubes 328 covered by the first holder 320. Specifically, the ribs 320a have a cross-shaped cross section. Thus, the ribs 320a abutted on the main body 330a of the lamp clip 330 can be effectively stabilized.

### Fifth Embodiment

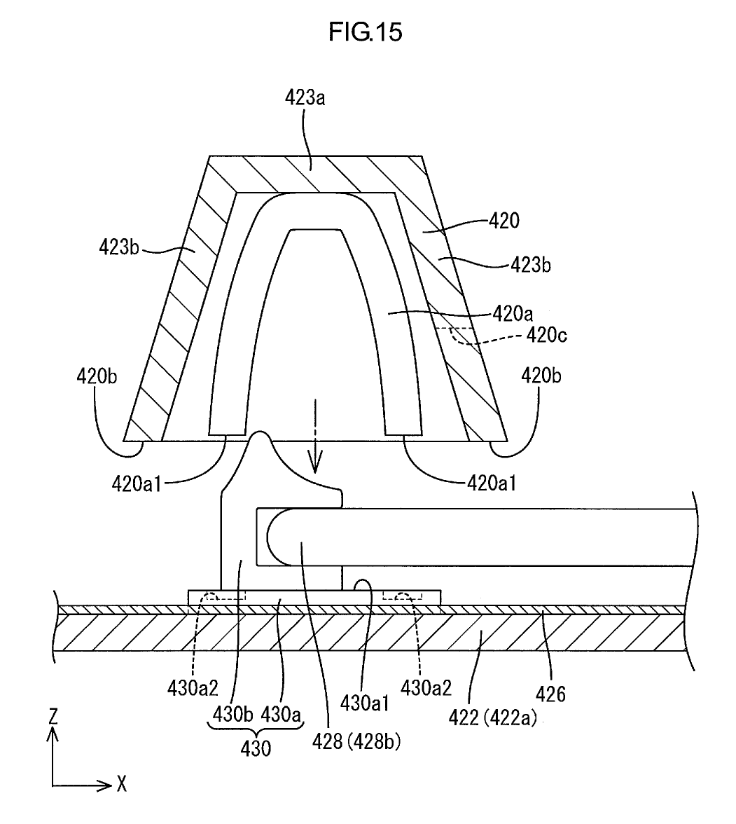

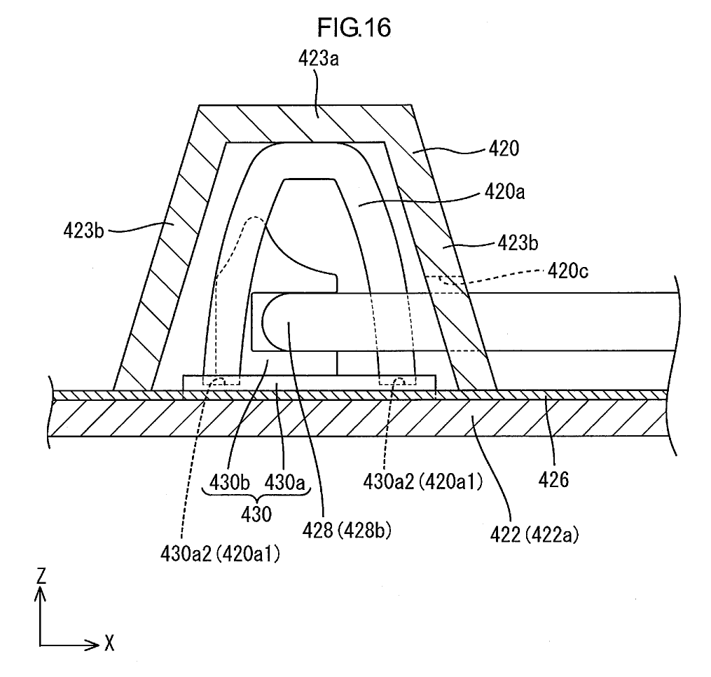

With reference to the drawings, a fifth embodiment will be described. FIG. 15 is an enlarged cross sectional view according to the fifth embodiment, corresponding to FIG. 5 for the first embodiment. FIG. 16 is an enlarged cross sectional view according to the fifth embodiment, corresponding to FIG. 7 for the first embodiment. The fifth embodiment differs from the first embodiment in that a lamp clip 430 includes recesses 430a2 into which a rib 420a is inserted. In FIGS. 15 and 16, portions designated by adding the number 400 to the reference numerals shown in FIGS. 5 and 7 are identical to the corresponding portions described with reference to the first embodiment.

In the backlight unit according to the fifth embodiment, the recesses 430a2 are formed in a main body 430a of the lamp clip 430 at positions where bottom surfaces 420a1 of the both legs of the rib 420a are abutted. When the lamp clip 430 is covered by a first holder 420, the bottom surfaces 420a1 of the both legs of the rib 420a are inserted into the recesses 430a2. Thus, according to the present embodiment, the rib 420a can be fixed onto the main body 430a of the lamp clip 430 such that the rib 420a abutting on the main body 430a may be hard to be separated from the main body 430a.

### Sixth Embodiment

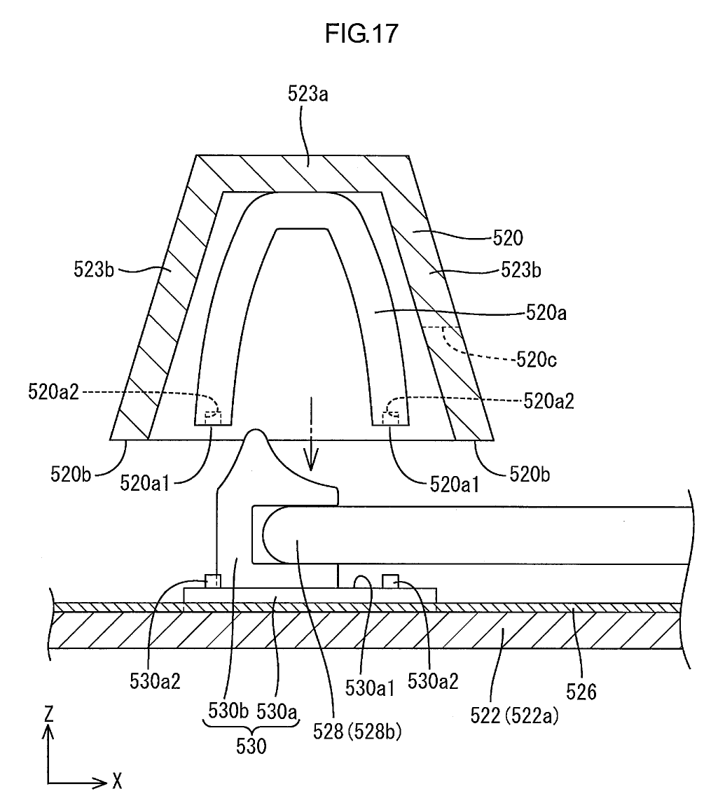

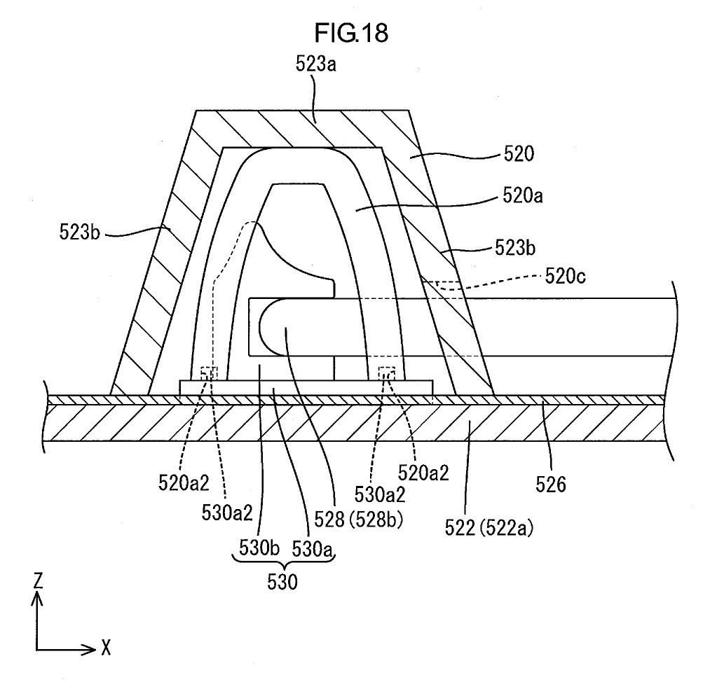

With reference to the drawings, a sixth embodiment will be described. FIG. 17 is an enlarged cross sectional view according to the sixth embodiment corresponding to FIG. 5 for the first embodiment. FIG. 18 is an enlarged cross sectional view according to the sixth embodiment corresponding to FIG. 7 for the first embodiment. The sixth embodiment differs from the first embodiment in that a lamp clip 530 includes protrusions 530a2 inserted into a rib 520a. In FIGS. 17 and 18, portions designated by adding the number 500 to the reference numerals shown in FIGS. 5 and 7 are identical to the corresponding portions described with reference to the first embodiment.

In the backlight unit according to the sixth embodiment, the protrusions 530a2 are formed on a main body 530a of the lamp clip 530 at positions where bottom surfaces 520a1 of the both legs of the rib 520a are abutted. Further, recesses 520a2 engaging with the protrusions 530a1 formed on the main body 530a are formed in the bottom surfaces 520a1 of the both legs of the rib 520a. When the lamp clip 530 is covered by the first holder 520, the protrusions 530a2 of the main body 530a are inserted into the recesses 520a2 in the bottom surfaces 520a1 of the both legs of the rib 520a. Thus, according to the present embodiment, the rib 520a can be fixed onto the main body 530a of the lamp clip 530 such that the rib 520a abutting on the main body 530a may be hard to be separated from the main body 530a.

### Seventh Embodiment

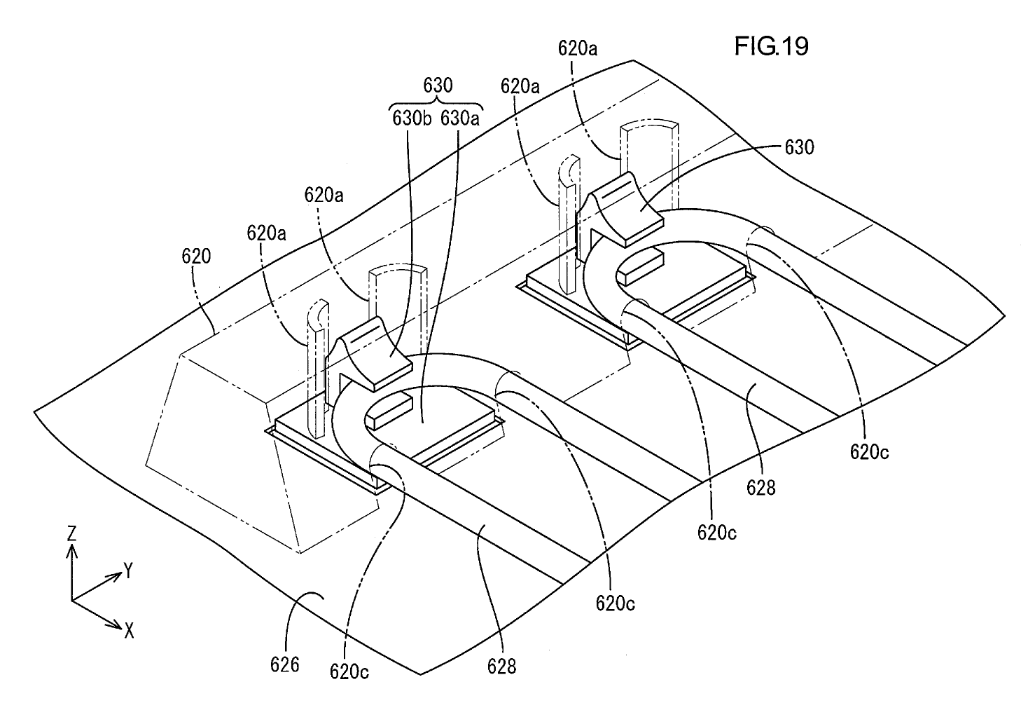

With reference to the drawings, a seventh embodiment will be described. FIG. 19 is an enlarged perspective view of curved portions 628b of discharge tubes 628 after a first holder 620 is attached, as viewed from diagonally above. The seventh embodiment differs from the first embodiment in the shape of ribs 620a. In FIG. 19, portions designated by adding the number 600 to the reference numerals shown in FIG. 8 are identical to the corresponding portions described with reference to the first embodiment.

In the backlight unit according to the seventh embodiment, the ribs have a plate-like shape extending from an inner side of the first holder 620 toward a main body 630a of a lamp clip 630 when the curved portion 628b of the discharge tube 628 is covered by the first holder 620. Further, the ribs 620a are curved in a direction (an X-Y plane direction in FIG. 19) orthogonal to a direction where the ribs 620a extend. Thus, the ribs 620a have a curved cross sectional shape. Therefore, the ribs 620a abutting on the main body 630a of the lamp clip 630 can be effectively stabilized.

### Eighth Embodiment

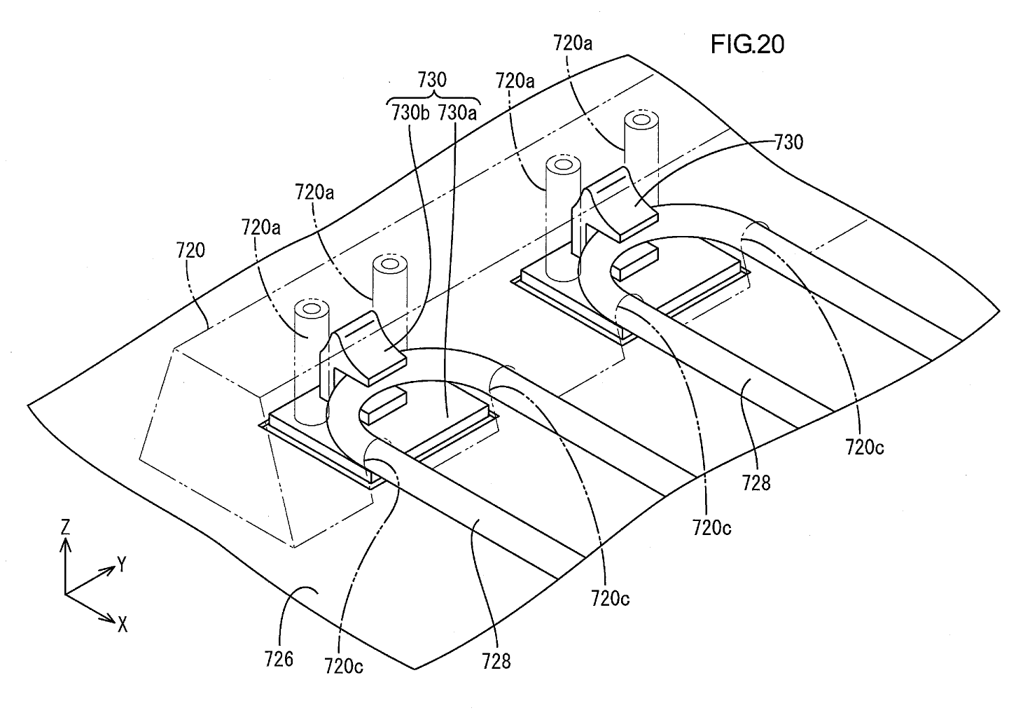

With reference to the drawings, an eighth embodiment will be described. FIG. 20 is an enlarged perspective view of curved portions 728b of discharge tubes 728 after a first holder 720 is attached, as viewed from diagonally above. The eighth embodiment differs from the first embodiment in the shape of ribs 720a. In FIG. 20, portions designated by adding the number 700 to the reference numerals shown in FIG. 8 are identical to the corresponding portions described with reference to the first embodiment.

In the backlight unit according to the eighth embodiment, the ribs 720a have a cylindrical shape extending from an inner side of the first holder 720 toward a main body 730a of a lamp clip 730 when the curved portion 728b of the discharge tubes 728 is covered by the first holder 720. Thus, the ribs 720a have a ring-shaped cross section. Therefore, the ribs 720a abutting on the main body 730a of the lamp clip 730 can be effectively stabilized.

Correspondence between the configurations of the embodiments and the configuration of the present invention will be noted. The backlight chassis 22, 122, 322, 422, and 522 are examples of a “chassis”. The lamp rubbers 30b, 130b, 230b, 330b, 430b, and 530b are examples of an “elastic gripping member”. The lamp clips 30, 130, 230, 330, 430, and 530 are examples of a “discharge tube attaching member”. The first holders 20, 120, 220, 420, and 520 are examples of a “holder”.

Modifications of the foregoing embodiments are listed below.

(1) The shape and the like of the ribs are not limited as long as the ribs can be abutted on the main body of the lamp clip and are spaced apart from the lamp rubber.

(2) Other than the foregoing embodiments, the shape, number and the like of the discharge tubes may be modified as appropriate.

(3) Other than the foregoing embodiments, the number, shape, arrangement and the like of the ribs of the first holder, and the manner in which the ribs are abutted on the main body of the lamp clip, for example, may be modified as appropriate.

(4) While in the foregoing embodiments cold cathode tubes are used as the discharge tubes, other types of discharge tube may be used.

(5) While in the foregoing embodiments liquid crystal display devices using a liquid crystal panel as a display panel has been described by way of example, the present invention may be applied to display devices using other types of display panels.

(6) While in the foregoing embodiments a television device with a tuner has been described by way of example, the present invention may be applied to a display device without a tuner.

While the present invention has been described in detail with reference to the embodiments, the embodiments are merely exemplary and do not limit the scope of the claims. The technology described in the claims may include various modifications and changes made to the specific examples described above.

The technical elements described in the present specification or drawings may provide technical utility either individually or in various combinations, and are not limited to the combinations described in the claims as filed. The technology described in the present specification or drawings may achieve multiple objects simultaneously, and may provide technical utility by achieving even one of the objects.

### Explanation of Symbols

TV: Television device, Ca, Cb: Cabinet, T: Tuner, S: Stand, 10: Liquid crystal display device, 12: Bezel, 14: Frame, 16: Liquid crystal panel, 18: Optical member, 20, 120, 220, 420, 520, 620, 720: First holder, 20a, 120a, 220a, 320a, 420a, 520a, 620a, 720a: Rib, 20b: Side edge, 20c: Cutout, 21: Second holder, 22, 122, 222, 322, 422, 522: Backlight chassis, 22a: Bottom plate, 22b: Side plate (in longitudinal direction), 22c: Side plate (in transverse direction), 23a: Upper surface, 23b: First side wall,23c: Second side wall, 24, 124, 224, 324: Backlight unit, 28, 128, 228, 328, 428, 528: Discharge tube, 28a, 128a, 228a, 328a: Electrode, 28b, 128b, 228b, 328b, 428b, 528b: Curved portion, 28c, 128c, 228c: Tube portion, 30, 130, 230, 330, 430, 530, 630, 730: Lamp clip, 30a, 130a, 230a, 330a, 430a, 530a, 630a, 730a: Main body, 30b, 130b, 230b, 330b, 430b, 530b, 630b, 730b: Lamp rubber, 320: Holder

1. A lighting device comprising:
a discharge tube including a tube having a curved portion, the curved portion being formed by bending a part of the tube;
a chassis including a bottom surface and housing the discharge tube on one side of the bottom surface;
a discharge tube attaching member including a main body and an elastic gripping member, the main body being attached to the bottom surface of the chassis, the elastic gripping member being provided on the main body and elastically gripping the curved portion of the discharge tube; and
a holder covering the curved portion of the tube of the discharge tube, the holder including a rib protruding in the holder, the rib being in contact with the main body of the tube of the discharge tube attaching member and spaced apart from the elastic gripping member of the discharge tube attaching member, with the curved portion of the discharge tube covered by the holder.

2. The lighting device according to claim 1, wherein
the rib included in the holder includes a plurality of ribs, and
the ribs are in contact with the main body of the discharge tube attaching member, with the curved portion of the tube of the discharge tube covered by the holder.

3. The lighting device according to claim 2, wherein the ribs included in the holder are each arranged on each side of the elastic gripping member of the discharge tube attaching member, with the curved portion of the discharge tube covered by the holder.

4. The lighting device according to claim 1, wherein the rib included in the holder is in contact with the main body of the discharge tube attaching member at a plurality of locations of the rib, with the curved portion of the discharge tube covered by the holder.

5. The lighting device according to claim 1, wherein the rib included in the holder has a blunt distal portion.

6. The lighting device according to claim 1, wherein the rib included in the holder has a shape tapering toward the main body of the discharge tube attaching member, with the curved portion of the discharge tube covered by the holder.

7. The lighting device according to claim 6, wherein the rib included in the holder has a substantially conical shape.

8. The lighting device according to claim 6, wherein the rib included in the holder has a substantially pyramidal shape.

9. The lighting device according to claim 1, wherein the rib included in the holder includes two plates intersecting with each other at a right angle, the two plates protruding in the holder toward the main body of the discharge tube attaching member, with the curved portion of the discharge tube covered by the holder.

10. The lighting device according to claim 1, wherein the rib included in the holder has a plate-like shape curved in a direction perpendicular to a direction in which the rib extends, the rib protruding in the holder toward the main body of the discharge tube attaching member, with the curved portion of the discharge tube covered by the holder.

11. The lighting device according to claims 1, wherein the rib of the holder has a cylindrical shape protruding in the holder toward the main body of the discharge tube attaching member, with the curved portion of the discharge tube covered by the holder.

12. The lighting device according to claim 1, wherein the rib of the holder includes a two-pronged distal portion.

13. The lighting device according to claim 12, wherein
the rib included in the holder has an arch-like shape with two legs, and
the discharge tube passes between the legs of the rib, with the curved portion of the discharge tube covered by the holder.

14. The lighting device according to claim 13, wherein the legs of the holder having the arch-like shape each include a bottom surface that is in contact with the main body of the discharge tube attaching member, with the curved portion of the discharge tube covered by the holder.

15. The lighting device according to claim 1, wherein the elastic gripping member of the discharge tube attaching member grips the curved portion of the tube of the discharge tube by sandwiching the curved portion from both sides thereof.

16. The lighting device according to claim 1, wherein the elastic gripping member of the discharge tube attaching member grips a middle portion of the curved portion of the tube of the discharge tube.

17. The lighting device according to claim 1, wherein the main body of the discharge tube attaching member has a plate-like shape.

18. The lighting device according to claim 1, wherein the main body of the discharge tube attaching member has a truncated pyramidal shape.

19-28. (canceled)

29. A display device comprising a display panel configured to provide display using light from the lighting device according to claim 1.

30. (canceled)

31. A television device comprising the display device according to claim 29.
